(19) United States
(12) Patent Application Publication
(10) Pub. No.: US 2026/0145984 A1
(43) Pub. Date: May 28, 2026

(54) EXPANDING TIP PLUGS AND METHOD OF USING AND MAKING THE SAME

(71) Applicant: CORNING INCORPORATED, CORNING, NY (US)

(72) Inventors: Antoine Gaston Denis Bisson, Painted Post, NY (US); Alper Ozturk, Corning, NY (US); Dale Robert Powers, Painted Post, NY (US); Ian Anthony Smith, Kure Beach, NC (US)

(21) Appl. No.: 19/394,562

(22) Filed: Nov. 19, 2025

Related U.S. Application Data
(60) Provisional application No. 63/725,721, filed on Nov. 27, 2024.

(51) Int. Cl. C03B 37/018

(52) U.S. Cl. CPC C03B 37/01861; C03B 37/01853; C03B 2201/02

(57) ABSTRACT

A method of processing a soot preform having a center hole may include: providing a tip plug, at least one portion of which may be received inside the center hole of the soot preform; exposing the tip plug to an elevated temperature greater than or equal to 1100° C.; and exposing the tip plug to a pressure less than or equal to 1 atm. In some embodiments, exposing the tip plug to the elevated temperature and/or the reduced pressure may cause the at least one portion of the tip plug to expand, thereby sealing the center hole of the soot preform. In some embodiments, the soot preform may porous until the center hole of the soot preform may be sealed by the tip plug.

### CROSS-REFERENCE TO RELATED APPLICATIONS

This application claims the benefit of priority under 35 U.S.C. § 119 of U.S. Provisional Application Ser. No. 63/725,721, filed on Nov. 27, 2024, the content of which is relied upon and incorporated herein by reference in its entirety.

### FIELD OF THE DISCLOSURE

This disclosure pertains to optical fibers. More particularly, this disclosure pertains to materials and components used for processing optical fiber preforms.

### BACKGROUND

During manufacturing of optical fibers, fiber preforms are typically used for drawing the optical fibers therefrom. The composition, e.g., radial compositional profile, of the fiber preform can affect the optical profile of the optical fiber drawn. Thus, there is a need for improved manufacturing systems and/or processes for obtaining desired compositional profile of the fiber preform.

### SUMMARY

In some embodiments, a method of processing a soot preform having a center hole may include: providing a tip plug, wherein at least one portion of the tip plug may be received inside the center hole of the soot preform; exposing the tip plug to an elevated temperature that may be greater than or equal to 1100° C.; and exposing the tip plug to a pressure that may be less than or equal to 1 atm. In some embodiments, exposing the tip plug to the elevated temperature and/or exposing the tip plug to the reduced pressure may cause the at least one portion of the tip plug to expand, thereby sealing the center hole of the soot preform. In some embodiments, an expansion ratio of the at least one portion of the tip plug may be greater than or equal to 1.05 within a period of less than or equal to 30 minutes, with the expansion ratio being defined as a ratio of a volume of the at least one portion of the tip plug at the end of the period to a volume of the at least one portion of the tip plug prior to expansion. In some embodiments, the soot preform may porous until the center hole of the soot preform may be sealed by the tip plug.

In some embodiments, a tip plug may be configured for sealing a center hole of a soot preform during at least one processing step for processing the soot preform while the soot preform may remain porous during the at least one processing step. The tip plug may include a glass composition including: SiO₂ in an amount that may be greater than or equal to 90 mol % and less than or equal to 99.9 mol %; and a foaming agent. In some embodiments, the foaming agent may be configured to cause the tip plug to expand during the at least one processing step, thereby sealing the center hole of the soot preform without causing a gas to be released from the tip plug into the center hole of the soot preform. In some embodiments, the viscosity of the glass composition may be less than or equal to 10⁹ poise at 1100° C. and/or greater than or equal to 10⁵ poise at 1400° C.

In some embodiments, a tip plug may be configured for sealing a center hole of a soot preform during at least one processing step for processing the soot preform. The tip plug may include a shaft including a first end, a second end, and a through hole extending through the first end and the second. The tip plug may further include a cap coupled to the first end of the shaft and defining a compartment. In some embodiments, the through hole of the shaft may be configured for establishing fluid communication between the compartment defined by the cap and an environment in which the soot preform may be processed during the at least one processing step. In some embodiments, the tip plug may further include an expanding pellet disposed inside the compartment. In some embodiments, the expanding pellet may be configured to expand during the at least one processing step, thereby causing the cap to expand and laminate to an interior surface of the soot preform defining the center hole of the soot preform to seal the center hole of the soot preform.

Additional features and advantages will be set forth in the detailed description which follows, and in part will be readily apparent to those skilled in the art from the description or recognized by practicing the embodiments as described in the written description and claims hereof, as well as the appended drawings. It is to be understood that both the foregoing general description and the following detailed description are merely exemplary and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings are illustrative of selected aspects of the present disclosure, and together with the description serve to explain principles and operation of methods, products, and compositions embraced by the present disclosure.

FIG. 1 schematically illustrates an exemplary soot preform.

FIG. 2 schematically illustrates a tip portion of the soot preform of FIG. 1 and a tip plug for sealing the center hole of the soot preform.

FIG. 3 plots exemplary relative refractive index profiles of optical fibers drawn from fiber preforms processed from soot preforms similar to the soot preform of FIG. 1.

FIG. 4 shows a glass body formed from a glass composition containing a foaming agent.

FIG. 5 plots modeled viscosity of exemplary silica glass compositions incorporating fluorine at various concentrations as a function of temperature.

FIG. 6A plots concentrations of exemplary halide foaming agents that may be incorporated into glass compositions for forming a tip plug as a function of the pressure at which the foaming agent may be incorporated using high pressure doping.

FIG. 6B plots the relative refractive index of the glass compositions of FIG. 6A as a function of the pressure at which the foaming agent may be incorporated.

FIG. 7 plots the modeled volume expansion of a tip plug as a function of time when the tip plug is held at 1600° C.

FIG. 8 plots the modeled volume expansion of exemplary glass compositions into which a foaming agent may be incorporated at different doping pressures as a function of time.

FIG. 9 plots the modeled volume expansion of exemplary glass compositions with different nucleating agent concentrations as a function of time.

FIGS. 10A and 10B schematically illustrate another exemplary tip plug for sealing the center hole of a soot preform.

FIGS. 11A, 11B, and 11C illustrate the expansion behavior of an exemplary expanding pellet.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purposes of describing particular aspects only and is not intended to be limiting.

In this specification and in the claims which follow, “greater than or equal to” and “≥” are used interchangeably, “less than or equal to” and “≤” are used interchangeably, “greater than” and “>” are used interchangeably, and “less than” and “<” are used interchangeably. When a parameter is described as greater than or equal to (or simply, ≥) a value, the parameter may be greater than (>) the referenced value or equal to (=) the referenced value. Similarly, when a parameter is described as less than or equal to (or simply, ≤) a value, the parameter may be less than (<) the referenced value or equal to (=) the referenced value.

Reference will now be made in detail to illustrative embodiments of the present description.

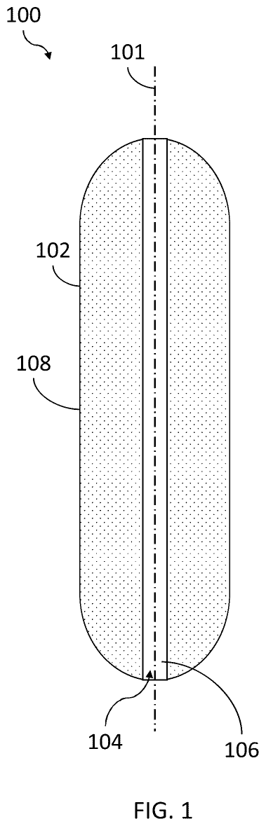

During optical fiber and/or fiber preform manufacturing, a soot preform, such as a preform formed from silica soot, may be utilized as an intermediate product. FIG. 1 schematically illustrates an exemplary soot preform 100. In some embodiments, the soot preform 100 may include a body 102 having a centerline 101 and a center hole 104 extending along and about the centerline 101 and defined by an interior surface 106 of the soot preform 100.

In some embodiments, the soot preform 100 may be processed, such as by doping one or more portions of the soot preform with one or more processing gases, such as up-dopants and/or down-dopants. In some embodiments, the up-dopants may include germanium (e.g., GeO₂), phosphorus (e.g., P₂O₅), aluminum (e.g. Al₂O₃), chlorine, and/or alkali metal oxides (e.g. Na₂O, K₂O, Li₂O, Cs₂O, and/or Rb₂O). In some embodiments, the down-dopants may include fluorine and/or boron. Although not explicitly shown in FIG. 1, in some embodiments, the soot preform 100 may include radially varying compositions from the interior surface 106 to the exterior surface 108 of the soot preform 100. In some embodiments, the soot preform 100 may include a substantially consistent or uniform composition with or without dopant.

In some embodiments, the processing gas, e.g., dopant in a gaseous form, may be introduced into the soot preform 100 via diffusion, such as diffusion from an exterior surface 108 of the soot preform 100 towards the centerline 101 of the soot preform 100, while the soot preform 100 may remain porous and/or may not be consolidated or sintered. During such process, the processing gas may also enter the center hole 104 of the soot preform 100 from the open end of the tip portion of the soot preform 100. In some embodiments, it may be desirable to limit processing gas ingress into the center hole 104 as the processing gas may alter the optical profile (e.g., refractive index profile) of the optical fiber drawn from a fiber preform processed from the soot preform 100. Further, processing gas ingress may also result in preform losses (e.g., core cane losses) near the tip portion of the soot preform 100. Thus, in some embodiments, it may be desired to seal the center hole 104 prior to introducing the processing gas so as to prevent processing gas ingress into the center hole 104.

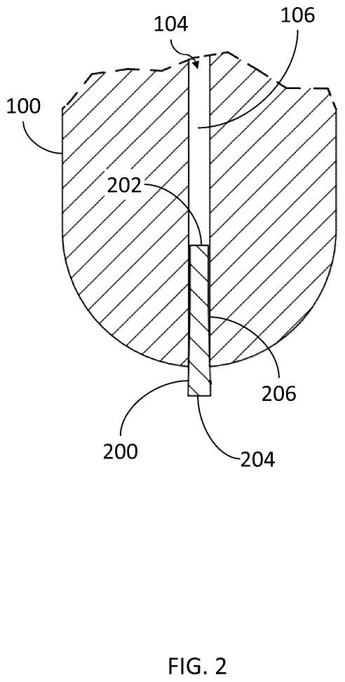

In some embodiments, a tip plug 200 may be utilized to limit the processing gas ingress, such as shown in FIG. 2, which schematically illustrates a tip portion of the soot preform 100 and the tip plug 200. In some embodiments, the tip plug 200 may be tapered. The tip plug 200 may include a first end 202 having a diameter smaller than the diameter of the center hole 104. The diameter of the tip plug 200 may gradually increase toward a second end 204 of the tip plug 200 opposite the first end 202. At least a portion of the tip plug 200, such as the portion near the second end 204, may include a diameter greater than the diameter of the center hole 104 of the soot preform 100. The first end 202 of the tip plug 200 may be placed into the center hole 104 of the soot preform 100, and the tip plug 200 may be held in place via friction fit, creating a seal between the tip plug 200 and the soot preform 100. It should be noted that although only one tip portion of the soot preform 100 is shown in FIG. 2 for purpose of illustration, the opposite tip portion of the soot preform 100 (not shown in FIG. 2) may also be sealed by another tip plug similar to the tip plug 200 or other component, such as a handle, or may be a closed end without requiring further sealing, to prevent processing gas ingress.

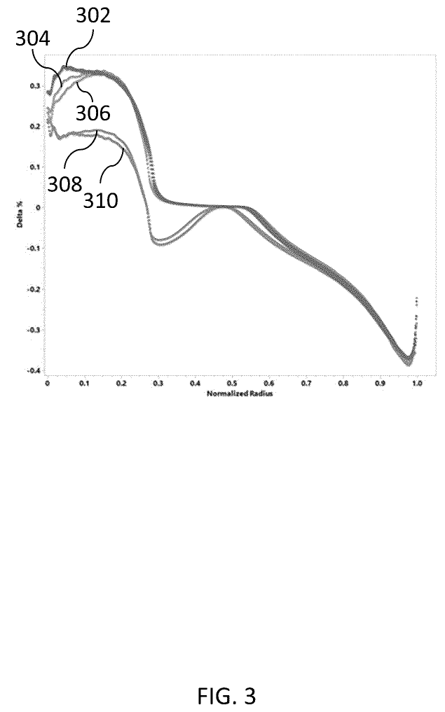

An existing method of limiting processing gas ingress includes placing a fully densified quartz tip plug having a shape similar to the tip plug 200 shown in FIG. 2 into the center hole 104 of the porous soot preform 100 to form a soot-to-glass seal between the fully densified quartz tip plug and the soot preform 100. FIG. 3 plots exemplary relative refractive index profiles of optical fibers drawn from fiber preforms processed from soot preforms similar to the soot preform 100 described herein. In the examples shown in FIG. 3, the soot preforms are each processed by doping the soot preforms with a down-dopant, e.g., fluorine, from the exterior surface of each soot preform via diffusion, and during processing, the center hole of each of the soot preforms is plugged by a fully densified quartz tip plug.

Profile 302 represents an optical fiber drawn from a fiber preform processed from a soot preform that has minimal processing gas ingress into the center hole of the soot preform during doping; profiles 304, 306 represent optical fibers drawn from fiber preforms processed from soot preforms that each have some processing gas ingress into the center holes during doping; and profiles 308, 310 represent optical fibers drawn from fiber preforms processed from soot preforms that each have more processing gas ingress into the center holes during doping. As shown, the friction seal between the fully densified quartz tip plug and the soot preform can be unreliable in preventing processing gas ingress, and as the processing gas ingress increases, the relative refractive index profile of the optical fiber drawn can be considerably altered, affecting the optical performance. Without intending to be bound by theory, although the fully densified quartz tip plug may limit processing gas ingress to some extent, the friction seal can be impacted by surface and/or geometry irregularities in the soot preform and/or the fully densified quartz tip plug, improper installation of the tip plug, damage to the soot preform, etc., creating gaps and/or flow paths for processing gas to enter into the center hole of the soot preform.

### Expanding Tip Plug

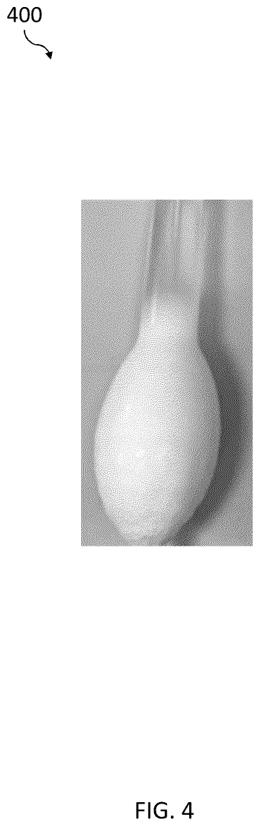

To control processing gas ingress into the center hole 104 while the soot preform 100 is being processed, such as being doped by one or more gaseous dopants prior to consolidation, in some embodiments, the tip plug 200 described herein may be configured to expand at elevated temperatures and/or reduced pressures to fill in any gaps and/or ingress path between the tip plug 200 and the soot preform 100, thereby providing an effective seal between the interior surface 106 of the soot preform 100 defining the center hole 104 and the tip plug 200 and preventing processing gas ingress. In some embodiments, expansion of the tip plug 200 may be achieved by forming the tip plug 200 (or at least a portion thereof, e.g., the portion received inside the center hole 104) with a glass composition that may include a foaming agent incorporated into a base matrix. In some embodiments, the foaming agent may convert from, e.g., a solid, to a gaseous phase at elevated temperatures and/or reduced pressures, forming fine gas inclusions and causing the tip plug 200 to expand. FIG. 4 shows a glass body 400 formed from a glass composition containing a foaming agent. As shown, a portion of the glass body 400 is expanded when the portion of the glass body 400 is exposed to elevated temperature and/or reduced pressure as will be discussed in more detail below.

### Base Matrix

In some embodiments, the glass composition may include silica (SiO₂) forming the base matrix. In some embodiments, the amount of SiO₂ in the glass composition may be greater than or equal to (i.e., ≥) 90 mol % and less than or equal to (i.e., ≤) 99.9 mol %—including all sub-ranges or values therebetween. For example, in some embodiments, the amount of SiO₂ in the glass composition may be ≥90 mol % and ≤99.9 mol %, ≥90 mol % and ≤96 mol %, ≥90 mol % and ≤93 mol %, ≥93 mol % and ≤99.9 mol %, ≥93 mol % and ≤96 mol %, or ≥96 mol % and ≤99.9 mol %. In some embodiments, the amount of SiO₂ in the glass composition may be greater than or equal to (i.e., ≥) 90 mol %, ≥91 mol %, ≥92 mol %, ≥93 mol %, ≥94 mol %, ≥95 mol %, ≥96 mol %, ≥97 mol %, ≥98 mol %, ≥99 mol %, or greater. In some embodiments, the amount of SiO₂ in the glass composition may be less than or equal to (i.e., ≤) 99.9 mol %, ≤99 mol %, ≤98 mol %, ≤97 mol %, ≤96 mol %, ≤95 mol %, ≤94 mol %, ≤93 mol %, ≤92 mol %, ≤91 mol %, or less.

### Viscosity Modifier

In some embodiments, the glass composition may further include one or more viscosity modifiers. The viscosity modifier described herein may tailor the viscosity of the glass composition so as to facilitate expansion of the tip plug 200 at various target temperature ranges during the processing of the soot preform 100. In some embodiments, the soot preform 100 may be processed while the soot preform 100 may not be consolidated or sintered. Thus, the soot preform 100 may be processed at a temperature lower than the consolidation/sintering temperature. For example, in some embodiments, the processing temperature at which the soot preform 100 may be processed may be less than or equal to (i.e., ≤) 1300° C., ≤1250° C., ≤1200° C., ≤1150° C., ≤1100° C., or less. The viscosity modifier may thus be included in the glass composition forming the tip plug 200 to lower the viscosity of the glass composition to facilitate the expansion of the tip plug 200 at the processing temperature of the soot preform 100 prior to consolidation of the soot preform 100, closing the tip end of the center hole 104 to prevent processing gas ingress.

### Viscosity

In some embodiments, the glass composition may have a viscosity greater than or equal to (i.e., ≥) 10⁵ poise and less than or equal to (i.e., ≤) 10⁹ poise—including all sub-ranges or values therebetween, in the temperature range of 1100° C. to 1400° C. In some embodiments, the viscosity of the glass composition may be less than or equal to (i.e., ≤) 10⁹ poise at 1100° C. Further, in some embodiments, the viscosity of the glass composition may be greater than or equal to (i.e., ≥) 10⁵ poise at 1400° C. The viscosity of the glass composition may be sufficiently low to allow effective and efficient expansion of the tip plug 200 but may also be sufficiently high to prevent any gas from escaping from the glass composition and entering into the center hole 104 of the tip plug 200.

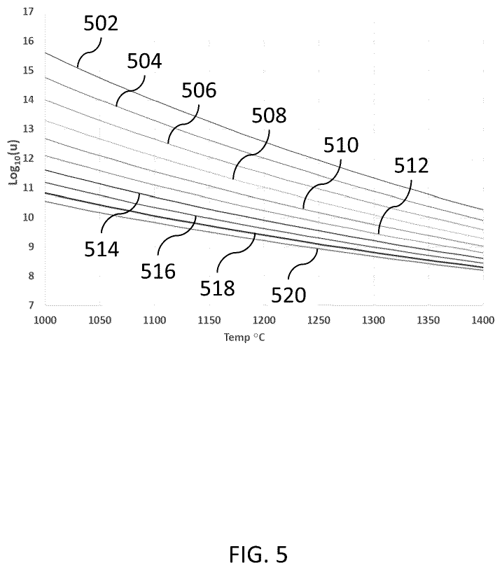

FIG. 5 plots the modeled viscosity of silica glass compositions incorporating fluorine at various concentrations (wt %) as the viscosity modifier as a function of temperature. Lines 502, 504, 506, 508, 510, 512, 514, 516, 518, 520 represent 0 wt %, 0.25 wt %, 0.5 wt %, 0.75 wt %, 1 wt %, 1.25 wt %, 1.5 wt %, 1.75 wt %, 2 wt %, 2.25 wt % of fluorine, respectively.

### Exemplary Viscosity Modifiers

Non-limiting exemplary viscosity modifiers may include phosphorus (P), fluorine (F), chlorine (Cl), boron (B), one or more alkali materials (e.g., materials containing one or more of lithium (Li), sodium (Na), potassium (K), rubidium (Rb), and/or cesium (Cs)), one or more alkaline earth materials (e.g., materials containing one or more of beryllium (Be), magnesium (Mg), calcium (Ca), strontium (Sr), and/or barium (Ba)), and so on. In some embodiments, the viscosity modifier may include a compound containing one or more aforementioned materials. In some embodiments, the viscosity modifier may include a bromide, an iodide, or a fluoride, such as a bromide, an iodide, or a fluoride of potassium (K) or sodium (Na).

### Amount of Viscosity Modifier

In some embodiments, the amount of viscosity modifier in the glass composition may be greater than or equal to (i.e., ≥) 1.5 mol % and less than or equal to (i.e., ≤) 5.5 mol %—including all sub-ranges or values therebetween. For example, in some embodiments, the amount of viscosity modifier in the glass composition may be ≥1.5 mol % and ≤5.5 mol %, ≥1.5 mol % and ≤4.5 mol %, ≥1.5 mol % and ≤3.5 mol %, ≥1.5 mol % and ≤2.5 mol %, ≥2.5 mol % and ≤5.5 mol %, ≥2.5 mol % and ≤4.5 mol %, ≥2.5 mol % and ≤3.5 mol %, ≥3.5 mol % and ≤5.5 mol %, ≥3.5 mol % and ≤4.5 mol %, or ≥4.5 mol % and ≤5.5 mol %. In some embodiments, the amount of viscosity modifier in the glass composition may be greater than or equal to (i.e., ≥) 1.5 mol %, ≥2 mol %, ≥2.5 mol %, ≥3 mol %, ≥3.5 mol %, ≥4 mol %, ≥4.5 mol %, ≥5 mol %, or greater. In some embodiments, the amount of viscosity modifier in the glass composition may be less than or equal to (i.e., ≤) 5.5 mol %, ≤5 mol %, ≤4.5 mol %, ≤4 mol %, ≤3.5 mol %, ≤3 mol %, ≤2.5 mol %, ≤2 mol %, or less.

### Method of Incorporation

In some embodiments, the viscosity modifier may be incorporated into the base matrix by diffusion. In some embodiments, the base matrix may be in the form of a porous body formed from glass particles by, e.g., depositing glass soot onto a substrate or rod, packing/pressing glass soot or powder into a mold, or any other suitable processes or techniques. The porous body of the base matrix may be exposed to an environment containing gas or vapor of the viscosity modifier, which may diffuse into the porous body of the base matrix. An exemplary process of incorporating the viscosity modifier into the base matrix is described in U.S. Patent Publication No. US2023/0167002, the content of which is incorporated by reference herein in its entirety for all purposes.

In some embodiments, the viscosity modifier may be incorporated into the porous body along with the base matrix material. For example, in some embodiments, particles or powder of the viscosity modifier may be mixed with the particles of the base matrix material in a soot pressing process and/or a casting process (discussed in more detail below) to form a porous body including the base matrix material and the viscosity modifier.

### Foaming Agent

### Volatile Foaming Agent

In some embodiments, the foaming agent may include a material that may volatilize at elevated temperatures and/or reduced pressures, causing the tip plug 200 to expand. As will be discussed in more detail below, the glass composition forming the tip plug 200 described herein may be supersaturated with the volatile foaming agent to facilitate expansion of the tip plug 200. In other words, the concentration of the foaming agent in the glass composition may be higher than the equilibrium concentration of the foaming agent achievable at atmospheric pressure.

### Amount of Volatile Foaming Agent

In some embodiments, the amount of the volatile foaming agent in the glass composition forming the tip plug 200 may be greater than or equal to (i.e., ≥) 1 mol % and less than or equal to (i.e., ≤) 10 mol %—including all sub-ranges or values therebetween. For example, in some embodiments, the amount of the volatile foaming agent in the glass composition forming the tip plug 200 may be ≥1 mol % and ≤10 mol %, ≥1 mol % and ≤7.5 mol %, ≥1 mol % and ≤5 mol %, ≥1 mol % and ≤2.5 mol %, ≥2.5 mol % and ≤10 mol %, ≥2.5 mol % and ≤7.5 mol %, ≥2.5 mol % and ≤5 mol %, ≥5 mol % and ≤10 mol %, ≥5 mol % and ≤7.5 mol %, or ≥7.5 mol % and ≤10 mol %. In some embodiments, the amount of the volatile foaming agent in the glass composition forming the tip plug 200 may be greater than or equal to (i.e., ≥) 1 mol %, ≥2 mol %, ≥3 mol %, ≥4 mol %, ≥5 mol %, ≥6 mol %, ≥7 mol %, ≥8 mol %, ≥9 mol %, or greater. In some embodiments, the amount of the volatile foaming agent in the glass composition forming the tip plug 200 may be ≤10 mol %, ≤9 mol %, ≤8 mol %, ≤7 mol %, ≤6 mol %, ≤5 mol %, ≤4 mol %, ≤3 mol %, ≤2 mol %, or less.

### Exemplary Volatile Foaming Agent

In some embodiments, the foaming agent may include a halogen-containing foaming agent. For example, in some embodiments, the foaming agent may include silicon halide. Non-limiting examples of the foaming agent may include SiF₄, SiCl₄, and/or SiBr₄. Depending on the particular foaming agent used, in some embodiments, the foaming agent may also function as a viscosity modifier, such as SiF₄ and/or SiCl₄, for reducing the viscosity of the glass composition of the tip plug 200. Accordingly, in some embodiments, the glass composition for forming the tip plug 200 may not include additional viscosity modifier.

### Method of Incorporation

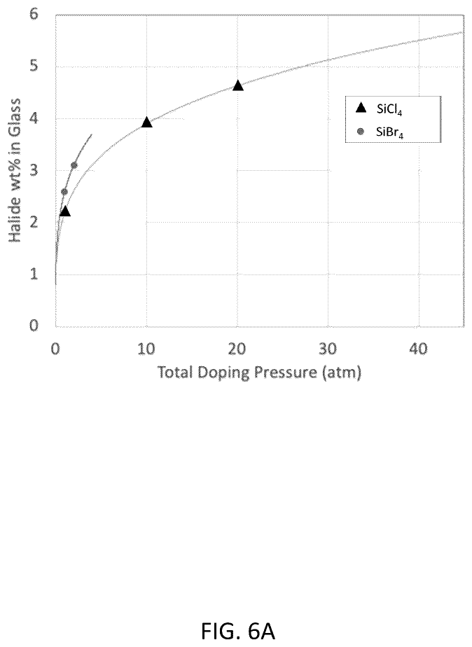

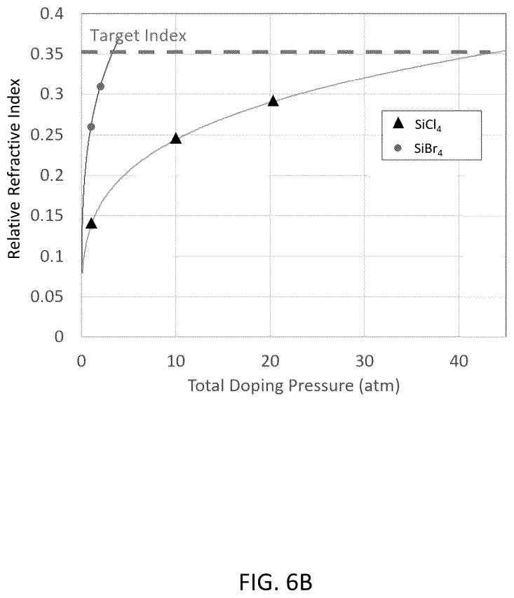

In some embodiments, the foaming agent may be incorporated into the base matrix by doping the base matrix at conditions where the solubility of the foaming agent in the base matrix may be high. For example, in some embodiments, high pressure doping may be employed to allow a higher concentration of the foaming agent to be incorporated into the base matrix as compared to the equilibrium concentration achievable at atmospheric pressure. FIG. 6A plots the concentrations of exemplary halide foaming agents that may be incorporated into glass compositions for forming the tip plug 200 as a function of the pressure at which the foaming agent may be incorporated using the high pressure doping process described in more detail below. As shown, increased pressure may allow greater concentration of the foaming agent to be incorporated into the glass composition forming the tip plug 200.

FIG. 6B plots the relative refractive index of the glass compositions of FIG. 6A as a function of the pressure at which the foaming agent may be incorporated. “Relative refractive index,” as used herein, is defined as:

$$Δ \% = 100 \frac{( {n}^{2} - {n}_{ref}^{2} )}{2 {n}^{2}}$$

where n is the refractive index of the glass composition, unless otherwise specified, and n_{ref} is the refractive index of pure silica glass, unless otherwise specified. Accordingly, as used herein, the relative refractive index is relative to pure silica glass, which has a value of 1.444 at a wavelength of 1550 nm. As used herein, the relative refractive index is represented by Δ (or “delta”) or Δ% (or “delta %) and its values are given in units of “%”, unless otherwise specified.

In some embodiments, the concentration of the foaming agent incorporated into the glass composition may be estimated based on the refractive index and/or the relative refractive index of the glass composition using the following relationships:

$$n \approx 1.4533 + 0.0014 \cdot wt {\%}_{C l}$$

$$or$$

$$Δ \% \approx 0.099 \cdot wt {\%}_{C l}$$

where n is the refractive index of the glass composition at 1550 nm, Δ% is the relative refractive index of the glass composition at 1550 nm, and wt %_{Cl} is the concentration of the Cl in the glass composition. Similar relationship between the refractive index of the glass composition and the concentration of the foaming agent SiBr₄ may be derived based on FIGS. 6A and 6B.

To incorporate the foaming agent, the porous body of the base matrix may be disposed in a heated enclosure, e.g., a furnace, into which the foaming agent in a gaseous state may be flowed. In some embodiments, the foaming agent may be flowed into the heated enclosure at high pressure so as to achieve a higher doping concentration of the foaming agent into the base matrix as compared to the equilibrium concentration at atmospheric pressure. Pressure levels may be selected in part based on the desired foaming agent concentration levels using plots such as shown in FIGS. 6A and 6B.

In some embodiments, the gaseous foaming agent inside the heated enclosure may have a pressure greater than or equal to (i.e., ≥) 1 atm and less than or equal to (i.e., ≤) 70 atm—including all sub-ranges or values therebetween. For example, in some embodiments, the gaseous foaming agent inside the heated enclosure may have a pressure ≥1 atm and ≤70 atm, ≥1 atm and ≤50 atm, 1 atm and ≤30 atm, 1 atm and ≤10 atm, ≥10 atm and ≤70 atm, ≥10 atm and ≤50 atm, 10 atm and ≤30 atm, ≥30 atm and ≤70 atm, ≥30 atm and ≤50 atm, or ≥50 atm and ≤70 atm. In some embodiments, the gaseous foaming agent inside the heated enclosure may have a pressure greater than or equal to (i.e., ≥) 1 atm, ≥5 atm, ≥10 atm, ≥15 atm, ≥20 atm, ≥25 atm, ≥30 atm, ≥35 atm, ≥40 atm, ≥45 atm, ≥50 atm, ≥55 atm, ≥60 atm, ≥65 atm, or greater. In some embodiments, the gaseous foaming agent inside the heated enclosure may have a pressure less than or equal to (i.e., ≤) 70 atm, ≤65 atm, ≤60 atm, ≤55 atm, ≤50 atm, ≤45 atm, ≤40 atm, ≤35 atm, ≤30 atm, ≤25 atm, ≤20 atm, ≤15 atm, ≤10 atm, ≤5 atm, or less.

In some embodiments, the elevated temperature at which the foaming agent may be doped into the base matrix may be greater than or equal to (i.e., ≥) 1200° C. and less than or equal to (i.e., ≤) 1400° C.—including all sub-ranges or values therebetween. For example, in some embodiments, the elevated temperature at which the foaming agent may be doped into the base matrix may be ≥1200° C. and ≤1400° C., ≥1200° C. and ≤1300° C., or ≥1300° C. and ≤1400° C. In some embodiments, the elevated temperature at which the foaming agent may be doped into the base matrix may be greater than or equal to (i.e., ≥) 1200° C., ≥1250° C., ≥1300° C., ≥1350° C., or greater. In some embodiments, the elevated temperature at which the foaming agent may be doped into the base matrix may be less than or equal to (i.e., ≤) 1400° C., ≤1350° C., ≤1300° C., ≤1250° C., or less. An exemplary apparatus for carrying out the high pressure doping is described in U.S. Patent Publication No. US2021/0179478, the content of which is incorporated by reference herein in its entirety for all purposes. The pressure and/or temperature values described herein may allow for sufficient amount of the volatile foaming agent to be incorporated into the glass composition to achieve effective and efficient expansion for sealing the center hole 104 of the soot preform 100 without causing any damage to the soot preform 100 due to the expansion of the tip plug 200 inside the center hole 104.

In some embodiments, incorporation of the foaming agent into the base matrix may be conducted prior to incorporating the viscosity modifier into the base matrix. In some embodiments, incorporation of the foaming agent may be conducted after incorporating the viscosity modifier into the base matrix. In some embodiments, incorporation of the foaming agent and the viscosity modifier into the base matrix may be conducted simultaneously.

Once a desired concentration of the foaming agent in the base matrix is achieved, the temperature inside the heated enclosure may be further increased so that the doped porous body may be consolidated to form a consolidated glass article. In some embodiments, the doped porous body may be fully consolidated to form a fully consolidated, glass article. In some embodiments, the doped porous body may be partially consolidated such that the glass article may include an exterior glass layer surrounding an interior portion which may remain porous.

After consolidation, the consolidated body may be cooled and removed from the enclosure. Despite the concentration of the foaming agent exceeding the equilibrium level, the increased viscosity of the glass composition as it is being cooled may restrict the foaming agent's tendency to convert into gas and escape from the consolidated body, resulting a glass composition supersaturated with the foaming agent that may be prone to foaming when reheated at elevated temperature and/or reduced pressure. Once cooled, in some embodiments, the consolidated body may be further processed, e.g., by machining, into the tip plug 200. In the embodiments where the tip plug 200 may be processed from a partially consolidated body, the processing may be conducted such that at least the portion of the tip plug 200 to be placed into the center hole 104 of the soot preform 100 may include an exterior glass layer encapsulating an interior that may be porous.

### Expansion Upon Reheating

When the tip plug 200 may be placed into the center hole 104 of the soot preform 100 for subsequently processing the soot preform 100 with a processing gas at an elevated temperature higher than room temperature, the tip plug 200 may be reheated. The elevated temperature may reduce the viscosity of the glass of the tip plug 200. Additionally, the pressure at which the soot preform 100 may be processed may be lower than the high pressure at which the foaming agent was incorporated into the base matrix. The relatively low pressure, in combination with the elevated temperature, may allow gas bubbles of the foaming agent to form, causing the glass structure of the tip plug 200 to expand to seal any gaps between the interior surface 106 of the soot preform 100 and the tip plug 200, preventing processing gas ingress into the center hole 104.

It should be noted that the tip plug 200 may be configured such that during expansion, the gas bubbles may remain contained within the glass structure of the tip plug 200, and no gas of the foaming agent may be released into the center hole 104 of the soot preform 100. In some embodiments, if any gas of the foaming agent may be released during expansion, the effect of the small amount, if any, of the foaming agent released on the optical performance of the optical fiber subsequently drawn may be negligible as compared to amount of the process gas ingress when a fully densified quartz tip plug is utilized. Further, the foaming agent may be selected such that it may not alter the optical performance significantly or adversely even if any release may happen as compared to the processing gas, e.g., a F-containing dopant, utilized for doping the soot preform 100 from the exterior surface 108 of the soot preform 100.

### Reactive Foaming Agent

In some embodiments, the foaming agent may include a material that may release one or more gases via chemical reactions. In some embodiments, the foaming agent may react with the base matrix to form a gaseous material at elevated temperatures and/or reduced pressures. In some embodiments, the foaming agent may react with the silica in the base matrix by reducing the silica in the base matrix and forming one or more gases that may cause the tip plug 200 to expand. In some embodiments, the foaming agent may release a gas product without reacting with the silica batch material. For example, in some embodiments, the foaming agent may decompose to release one or more gas products. Without intending to be bound by theory, the one or more gas products may have relatively low solubility in the silica matrix, and may eventually nucleate and grow, which may be facilitated by the tailored viscosity (via the viscosity modifier described herein) of the glass composition forming the tip plug 200.

### Exemplary Reactive Foaming Agent

Non-limiting examples of the reactive foaming agent may include a carbon-containing material, a silicon-containing material, a nitrogen-containing material, a sulfur-containing material, and/or other gas-releasing material. For example, in some embodiments, the reactive foaming agent may include silicon carbide (SiC), silicon nitride (Si₃N₄), activated charcoal (C), calcium sulfate (CaSO₄), calcium sulfite (CaSO₃), and the like.

### Amount of Reactive Foaming Agent

In some embodiments, the amount of the reactive foaming agent in the glass composition forming the tip plug 200 may be greater than or equal to (i.e., ≥) 0.01 mol % and less than or equal to (i.e., ≤) 1 mol %—including all sub-ranges or values therebetween. For example, in some embodiments, the amount of the reactive foaming agent in the glass composition forming the tip plug 200 may be ≥0.01 mol % and ≤1 mol %, ≥0.01 mol % and ≤0.75 mol %, ≥0.01 mol % and ≤0.5 mol %, ≥0.01 mol % and ≤0.25 mol %, ≥0.25 mol % and ≤1 mol %, ≥0.25 mol % and ≤0.75 mol %, ≥0.25 mol % and ≤0.5 mol %, ≥0.5 mol % and ≤1 mol %, ≥0.5 mol % and ≤0.75 mol %, or ≥0.75 mol % and ≤1 mol %.

In some embodiments, the amount of the reactive foaming agent in the glass composition forming the tip plug 200 may be greater than or equal to (i.e., ≥) 0.01 mol %, ≥0.05 mol %, ≥0.1 mol %, ≥0.15 mol %, ≥0.2 mol %, ≥0.25 mol %, ≥0.3 mol %, ≥0.35 mol %, ≥0.4 mol %, ≥0.45 mol %, ≥0.5 mol %, ≥0.55 mol %, ≥0.6 mol %, ≥0.65 mol %, ≥0.7 mol %, ≥0.75 mol %, ≥0.8 mol %, ≥0.85 mol %, ≥0.9 mol %, ≥0.95 mol %, or greater. In some embodiments, the amount of the reactive foaming agent in the glass composition forming the tip plug 200 may be less than or equal to (i.e., ≤) 1 mol %, ≤0.95 mol %, ≤0.9 mol %, ≤0.85 mol %, ≤0.8 mol %, ≤0.75 mol %, ≤0.7 mol %, ≤0.65 mol %, ≤0.6 mol %, ≤0.55 mol %, ≤0.5 mol %, ≤0.45 mol %, ≤0.4 mol %, ≤0.35 mol %, ≤0.3 mol %, ≤0.25 mol %, ≤0.2 mol %, ≤0.15 mol %, ≤0.1 mol %, ≤0.05 mol %, or less.

### Gas-Releasing Reactions

Table 1 lists some non-limiting foam/gas forming reactions at exemplary conditions that may produce gas products to facilitate the expansion of the tip plug 200 at elevated temperature and/or reduced pressure. In the exemplary reactions below, in addition to the gaseous products of carbon monoxide (CO), nitrogen (N₂), sulfur dioxide (SO₂), and/or oxygen (O₂), silicon monoxide (SiO) may also be a gas at and above, e.g., 1790° C. at 1 atm, or 1580° C. at 0.1 atm.

TABLE 1

| Foaming | | | | | |
|---|---|---|---|---|---|
| Agent | Reaction | @ 1 atm | | @ 0.1 atm | |
| C | SiO₂ + C → SiO + CO | 1520° | C. | 1330° | C. |
| SiC | 2SiO₂ + SiC → 3 SiO + | 1820° | C. | 1610° | C. |
| | CO | | | | |
| Si₃N₄ | Si₃N₄ → 3Si + 2N₂ | 1870° | C. | 1680° | C. |
| Si₃N₄ | Si₃N₄ + 3SiO₂ → 6SiO + | 1810° | C. | 1590° | C. |
| | 2N₂ | | | | |
| CaSO₄ | CaSO₄ + SiO₂ → CaSiO₃ + | 650-710° | C. | 550-620° | C. |
| | SO₂ + 1/2O₂ | | | | |
| CaSO₃ | CaSO₃ + SiO₂ → CaSiO₃ + | 640-710° | C. | 550-620° | C. |
| | SO₂ | | | | |

### Method of Incorporation

In some embodiments, the reactive foaming agent may be incorporated into the glass composition forming the tip plug 200 by embedding particles or powder of the reactive foaming material into the base matrix. For example, in some embodiments, particles of the reactive foaming agent may be mixed with silica powder in a soot pressing process or a casting processing (discussed in more detail below) to form the porous body which may be further processed (e.g., incorporating viscosity modifier, consolidating, machining, etc.) to form the tip plug 200.

### Nucleating Agent

In some embodiments, the glass composition forming the tip plug 200 may further include a nucleating agent to facilitate gas bubble nucleation (whether in the case of a supersaturated foaming agent incorporated at high pressure or in the case of a reactive foaming agent for releasing gases at elevated temperature and/or reduced pressure), thereby facilitating the expansion of the tip plug 200.

### Exemplary Nucleating Agent

In some embodiments, the nucleating agent may be intrinsic detects formed in the glass structure during manufacturing of the tip plug 200. In some embodiments, additional nucleating agent may be introduced into the glass composition. In some embodiments, the nucleating agent may include a relative stable or inert material. For example, in some embodiments, the nucleating agent may include a metal oxide, such as zirconium oxide (ZrO₂), titanium oxide (TiO₂), and the like. In some embodiments, the nucleating agent and the foaming agent may be the same, and thus, no additional nucleating agent may be needed. For example, in some embodiments, the reactive foaming agent described herein may function both as a foaming agent producing one or more gases and as a nucleating agent facilitating the growth of the gaseous products into stable bubbles. In some embodiments, the reactive foaming agent, which may be introduced as particles, may be utilized along with the volatile foaming agent, which may be introduced via high pressure doping, and the reactive foaming agent may function as both the nucleating agent for itself and for the volatile foaming agent.

### Size of Nucleating Agent

In some embodiments, the size of the nucleating agent particles may be greater than or equal to (i.e., ≥) 50 nm and less than or equal to (i.e., ≤) 50 um—including all sub-ranges or values therebetween. For example, in some embodiments, the size of the nucleating agent particles may be ≥50 nm and ≤50 μm, ≥50 nm and ≤25 μm, ≥50 nm and ≤1 μm, ≥50 nm and ≤500 nm, ≥50 nm and ≤100 nm, ≥100 nm and ≤50 μm, ≥100 nm and ≤25 μm, ≥100 nm and ≤1 μm, ≥100 nm and ≤500 nm, ≥500 nm and ≤50 μm, ≥500 nm and ≤25 μm, ≥500 nm and ≤1 μm, ≥1 μm and ≤50 μm, ≥1 μm and ≤25 μm, or ≥25 μm and ≤50 μm. In some embodiments, the size of the nucleating agent particles may be greater than or equal to (i.e., ≥) 50 nm, ≥100 nm, ≥200 nm, ≥300 nm, ≥400 nm, ≥500 nm, ≥600 nm, ≥700 nm, ≥800 nm, ≥900 nm, ≥1 μm, ≥5 μm, ≥10 μm, ≥15 μm, ≥20 μm, ≥25 μm, ≥30 μm, ≥35 μm, ≥40 μm, ≥45 μm, or greater. In some embodiments, the size of the nucleating agent particles may be less than or equal to (i.e., ≤) 50 μm, ≤45 μm, ≤40 μm, ≤35 μm, ≤30 μm, ≤25 μm, ≤20 μm, ≤15 μm, ≤10 μm, ≤5 μm, ≤1 μm, ≤900 nm, ≤800 nm, ≤700 nm, ≤600 nm, ≤500 nm, ≤400 nm, ≤300 nm, ≤200 nm, ≤100 nm, or less. When the particle size is relatively small, agglomeration may occur. The particle size described herein refers to the equivalent agglomerate size, if present.

### Amount of Nucleating Agent

In some embodiments, the amount of the nucleating agent in the glass composition forming the tip plug 200 may be greater than or equal to (i.e., ≥) 1% by volume (i.e., 1 vol %) and less than or equal to (i.e., ≤) 20% by volume (i.e., 20 vol %)—including all sub-ranges or values therebetween. For example, in some embodiments, the amount of the nucleating agent in the glass composition forming the tip plug 200 may be ≥1 vol % and ≤20 vol %, ≥1 vol % and ≤15 vol %, ≥1 vol % and ≤10 vol %, ≥1 vol % and ≤5 vol %, ≥5 vol % and ≤20 vol %, ≥5 vol % and ≤15 vol %, ≥5 vol % and ≤10 vol %, ≥10 vol % and ≤20 vol %, ≥10 vol % and ≤15 vol %, or ≥15 vol % and ≤20 vol %. In some embodiments, the amount of the nucleating agent in the glass composition forming the tip plug 200 may be greater than or equal to (i.e., ≥) 1 vol %, ≥3 vol %, ≥5 vol %, ≥7 vol %, ≥9 vol %, ≥11 vol %, ≥13 vol %, ≥15 vol %, ≥17 vol %, ≥19 vol %, or greater. In some embodiments, the amount of the nucleating agent in the glass composition forming the tip plug 200 may be ≤20 vol %, ≤18 vol %, ≤16 vol %, ≤14 vol %, ≤12 vol %, ≤10 vol %, ≤8 vol %, ≤6 vol %, ≤4 vol %, ≤2 vol %, or less. The various amounts of the nucleating agent described herein may allow effective expansion to be achieved.

### Method of Incorporation

In some embodiments, the nucleating agent may be in the form of inert particles, and may be incorporated into the glass composition similar to how the reactive foaming agent particles may be introduced into the glass composition as described above. For example, in some embodiments, particles of the nucleating agent may be mixed with particles of silica to form a porous body (e.g., via a soot pressing process) which may be further processed (e.g., incorporating viscosity modifier, consolidating, machining, etc.) to form the tip plug 200.

### Bubble Nucleation

Without intending to be bound by theory, when the tip plug 200 is subsequently exposed to elevated temperature and/or reduced pressure during processing the soot preform 100, the nucleating agent may enable the formation of gas bubbles from the foaming agent without significant surface energy, thereby facilitating the expansion of the tip plug 200 for sealing the center hole 104 of the soot preform 100.

### Method of Manufacturing

As discussed above, in some embodiments, the formation of the tip plug 200 may involve first forming a porous body of the base matrix. In some embodiments, the porous body may be formed via outside vapor deposition (OVD), vapor axial deposition (VAD), plasma-enhanced chemical vapor deposition (PCVD), modified chemical vapor deposition (MCVD), or any other known deposition method. In some embodiments, the porous body may be formed using a soot pressing process by pressing or packing particles or powders of the base matrix material, e.g., silica soot or powder, into a mold. In some embodiments, the porous body may be formed using a casting process. For example, in some embodiments, a suspension of the base matrix material, e.g., silica soot or powder, may be formed using appropriate dispersant and vehicle (e.g., a non-aqueous vehicle), and then allowed to gel in a mold. After gelation, the vehicle and dispersant may be removed via drying, and a porous body of the base matrix may be formed. Exemplary casting methods are described in U.S. Pat. Nos. 4,541,855, 4,561,872, and 4,574,063, the contents of which are incorporated by reference herein in their entireties for all purposes.

In some embodiments, the viscosity modifier, the foaming agent (e.g., the reactive foaming agent described herein), and/or the nucleating agent may be incorporated into the porous body along with the base matrix material. For example, in some embodiments, particles or powder of the viscosity modifier, the foaming agent, and/or the nucleating agent may be mixed with the base matrix material in the soot pressing process and/or the casting process described herein to form a porous body including the base matrix material, the viscosity modifier, the foaming agent, and the nucleating agent.

In some embodiments, the foaming agent, such as the volatile foaming agent described herein, may be incorporated into the glass composition forming the tip plug 200 after the formation of the porous body. For example, in some embodiments, the volatile foaming agent may be incorporated into the porous body via high pressure doping as described above. In some embodiments, the viscosity modifier may also be incorporated into the glass composition forming the tip plug 200 after the formation of the porous body via, e.g., doping as described above. The doping of the viscosity modifier and the doping of the volatile foaming agent may be conducted sequentially or simultaneously.

After incorporation of the desired concentration levels of the foaming agent, the nucleating agent, and/or the viscosity modifier in the porous body of the base matrix, the porous body may be consolidated to form a consolidated glass article, which may then be further processed, e.g., by machining, into the tip plug 200.

### Expanding Temperatures

In some embodiments, the temperature at which the tip plug 200 may expand due to the reduction of the viscosity and the formation of gas bubbles by the various foaming agents described herein may be greater than or equal to (i.e., ≥) 1100° C. and less than or equal to (i.e., ≤) 1700° C.—including all sub-ranges or values therebetween. In some embodiments, when a volatile foaming agent may be utilized, the temperature at which the tip plug 200 may expand may be greater than or equal to (i.e., ≥) 1100° C. and less than or equal to (i.e., ≤) 1400° C.—including all sub-ranges or values therebetween.

For example, in some embodiments, the temperature at which the tip plug 200 may expand may be ≥1100° C. and ≤1700° C., ≥1100° C. and ≤1600° C., ≥1100° C. and ≤1500° C., ≥1100° C. and ≤1400° C., ≥1100° C. and ≤1300° C., ≥1100° C. and ≤1200° C., ≥1200° C. and ≤1700° C., ≥1200° C. and ≤1600° C., ≥1200° C. and ≤1500° C., ≥1200° C. and ≤1400° C., ≥1200° C. and ≤1300° C., ≥1300° C. and ≤1700° C., ≥1300° C. and ≤1600° C., ≥1300° C. and ≤1500° C., ≥1300° C. and ≤1400° C., ≥1400° C. and ≤1700° C., ≥1400° C. and ≤1600° C., ≥1400° C. and ≤1500° C., ≥1500° C. and ≤1700° C., ≥1500° C. and ≤1600° C., or ≥1600° C. and ≤1700° C. In some embodiments, the temperature at which the tip plug 200 may expand may be greater than or equal to (i.e., ≥) 1100° C., ≥1150° C., ≥1200° C., ≥1250° C., ≥1300° C., ≥1350° C., ≥1400° C., ≥1450° C., ≥1500° C., ≥1550° C., ≥1600° C., ≥1650° C., or greater. In some embodiments, the temperature at which the tip plug 200 may expand may be less than or equal to (i.e., ≤) 1700° C., ≤1650° C., ≤1600° C., ≤1550° C., ≤1500° C., ≤1450° C., ≤1400° C., ≤1350° C., ≤1300° C., ≤1250° C., ≤1200° C., ≤1150° C., or less.

### Expanding Pressures

In some embodiments, the pressure at which the tip plug 200 may expand (also the pressure at which the soot preform 100 may be processed) may be greater than or equal to (i.e., ≥) 0 atm (or vacuum) and less than or equal to 1 atm—including all sub-ranges or values therebetween. In some embodiments, when a reactive foaming agent may be utilized, the pressure at which the tip plug 200 may expand may be greater than or equal to (i.e., ≥) 0 atm and less than or equal to (i.e., ≤) 0.3 atm—including all sub-ranges or values therebetween.

For example, in some embodiments, the pressure at which the tip plug 200 may expand may be ≥0 atm and ≤1 atm, ≥0 atm and ≤0.7 atm, ≥0 atm and ≤0.3 atm, ≥0.3 atm and ≤1 atm, ≥0.3 atm and ≤0.7 atm, or ≥0.7 atm and ≤1 atm. In some embodiments, the pressure at which the tip plug 200 may expand may be greater than or equal to (i.e., ≥) 0 atm, ≥0.1 atm, ≥0.2 atm, ≥0.3 atm, ≥0.4 atm, ≥0.5 atm, ≥0.6 atm, ≥0.7 atm, ≥0.8 atm, ≥0.9 atm, or greater. In some embodiments, the pressure at which the tip plug 200 may expand may be less than or equal to (i.e., ≤) 1 atm, ≤0.9 atm, ≤0.8 atm, ≤0.7 atm, ≤0.6 atm, ≤0.5 atm, ≤0.4 atm, ≤0.3 atm, ≤0.2 atm, ≤0.1 atm, or less.

### Expansion Ratio

The expansion ratio of the tip plug 200 described herein, as defined by the ratio of the expanded volume to the volume prior to expansion may be greater than or equal to (i.e., ≥) 1.05 and less than or equal to (i.e., ≤) 5—including all sub-ranges or values therebetween in various embodiments. For example, in some embodiments, the expansion ratio of the tip plug 200 may be ≥1.05 and ≤5, ≥1.05 and ≤4, ≥1.05 and ≤3, ≥1.05 and ≤2, ≥2 and ≤5, ≥2 and ≤4, ≥2 and ≤3, ≥3 and ≤5, ≥3 and ≤4, or ≥4 and ≤5. In some embodiments, the expansion ratio of the tip plug 200 may be greater than or equal to (i.e., ≥) 1.05, ≥1.5, ≥2, ≥2.5, ≥3, ≥3.5, ≥4, ≥4.5, or greater. In some embodiments, the expansion ratio of the tip plug 200 may be less than or equal to (i.e., ≤) 5, ≤4.5, ≤4, ≤3.5, ≤3, ≤2.5, ≤2, ≤1.5, or less. In some embodiments, the tip plug 200 may be configured such that an expansion ratio of greater than or equal to (i.e., ≥) 1.1 may be achieved within less than or equal to (i.e., ≤) 30 minutes such that the center hole 104 of the soot preform 100 may be sealed by the tip plug 200 quickly and effectively prior to introducing any processing gases for further processing the soot preform 100.

### Exemplary Embodiments of Tip Plug 200

### Example 1

Example 1 is an exemplary tip plug 200 formed from a glass composition having a silica (SiO₂) base matrix and silica tetrachloride (SiCl₄) as the foaming agent. The tip plug can be formed by introducing SiCl₄ into a silica soot blank via high pressure doping at 12 atm, followed by consolidation and optionally machining. Example 1 does not include additional viscosity modifier or nucleating agent, and intrinsic defects formed in the consolidated glass may serve as the nucleating agent.

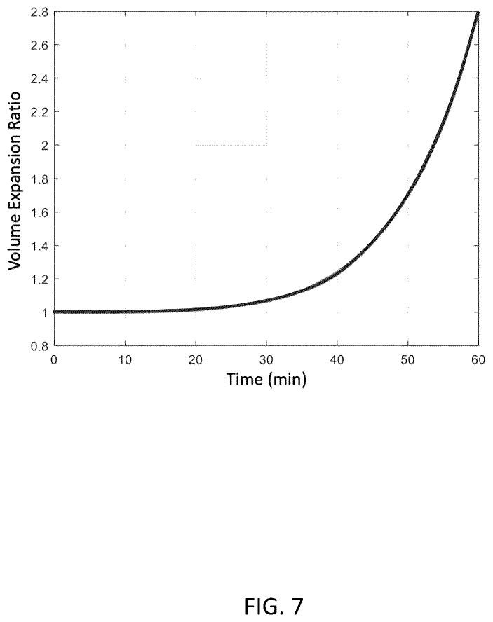

FIG. 7 is a plot modeling the volume expansion of the tip plug as a function of time when the tip plug is held at 1600° C. The viscosity of the glass composition of Example 1 at 1600° C. is about 7× 108 poise. Based on a desired volume increase for the tip plug to form an effective seal, the holding time may be determined accordingly. As a non-limiting example, for a tip plug having a 13 mm outer diameter to seal a center hole having a 15 mm inner diameter, a volume expansion ratio of about 1.54 (=(15 mm/13 mm) 3) may be needed, which may be achieved with a holding time of about 45 minutes as shown in the plot of FIG. 7.

### Example 2

Example 2 is another exemplary tip plug 200 formed from a glass composition having a silica (SiO₂) base matrix and silica tetrachloride (SiCl₄) as the foaming agent. Different from the tip plug 200 of Example 1, the tip plug 200 of Example 2 further includes an alkali, specifically, about 1 mol % potassium (K), as the viscosity modifier, for reducing the viscosity of the glass composition forming the tip plug 200 of Example 2. Specifically, the glass composition forming the tip plug 200 of Example 2 can achieve the same viscosity of 7×10⁸ poise at a much reduced temperature of 1150° C., in contrast to 1600° C. in Example 1. Thus, when configured with the same dimensions as Example 1 to achieve sealing within the same holding time of 45 minutes (e.g., volume expansion ratio of 1.54), the tip plug 200 of Example 2, with the addition of viscosity modifier, only needs to be heated to 1150° C. instead of 1600° C. as in the case of Example 1. It should be noted that the holding time and temperature discussed with reference to Examples 1 and 2 are for illustration purposes only, the glass composition of the tip plug 200 can be tailored to achieve any expansion ratios with desired holding time and/or temperature.

### Example 3

Example 3 demonstrates leveraging the doping pressure of the foaming agent to modify the expansion characteristics. As discussed above, in some embodiments, the foaming agent may be incorporated into the base matrix via high pressure doping. By adjusting the pressure at which the foaming agent may be doped into the base matrix, different volume expansions can be achieved at the same holding time and temperature.

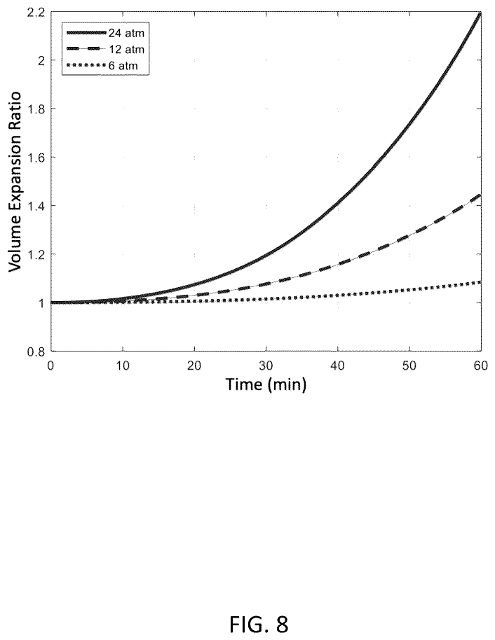

FIG. 8 is a plot modeling the volume expansion of exemplary glass compositions into which an exemplary foaming agent, specifically, silicon tetrachloride (SiCl₄), may be incorporated at different doping pressures, as a function of time. For the modeling shown in FIG. 8, each glass composition is assumed to have the same viscosity of 1×10⁹ poise at the holding temperature of ranging between 1250° C. and 1385° C. depending on the amount of chlorine present in the glass composition. As shown in FIG. 8, a doping pressure of 12 atm results in about 20% increase in volume (expansion ratio of about 1.04) for the same holding time of 45 minutes. A doping pressure of 24 atm results in greater propensity to foam and a volume expansion ratio of 1.54 can be achieved within 45 minutes. Without intending to be bound by theory, by increasing the doping pressure at which the foaming agent may be incorporated into the base matrix, a reduced holding time and/or temperature may be utilized to achieve desired expansion, which may in turn reduce the likelihood of devitrification associated with the use of an alkali as the viscosity modifier.

### Example 4

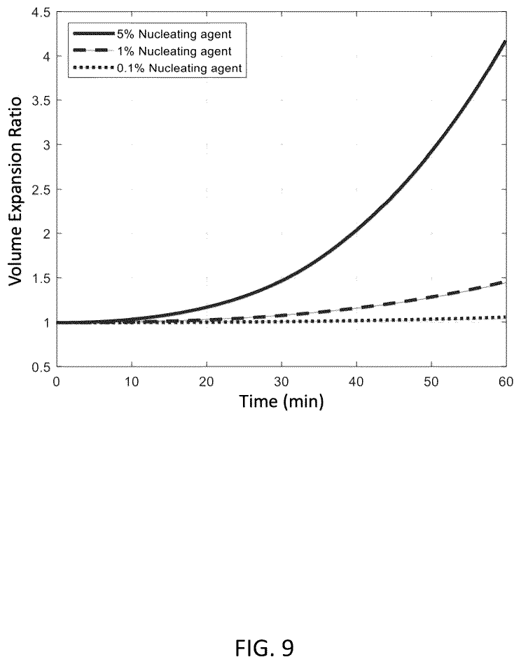

Example 4 demonstrates utilizing an additional nucleating agent, as an alternative or in addition to using the intrinsic defects in the glass structure, to modify the expansion characteristics. FIG. 9 is a plot modeling the volume expansion of exemplary glass compositions with different nucleating agent concentrations as a function of time. For the modeling shown in FIG. 9, each glass composition is assumed to have the same viscosity of about 5×10⁹ poise at the holding temperature of 1350° C., and a volatile foaming agent is incorporated into each glass composition at a doping pressure of 12 atm. As shown in FIG. 9, the addition of nucleating agent can accelerate the expansion of the tip plug significantly even with the relatively low foaming agent doping pressure of 12 atm for a relative high viscosity of about 5×10⁹ poise. Approximately 2 wt % nucleating agent can achieve a volume expansion ratio of about 1.54 within 45 minutes for the exemplary glass compositions of Example 4.

### Capped Expanding Tip Plug

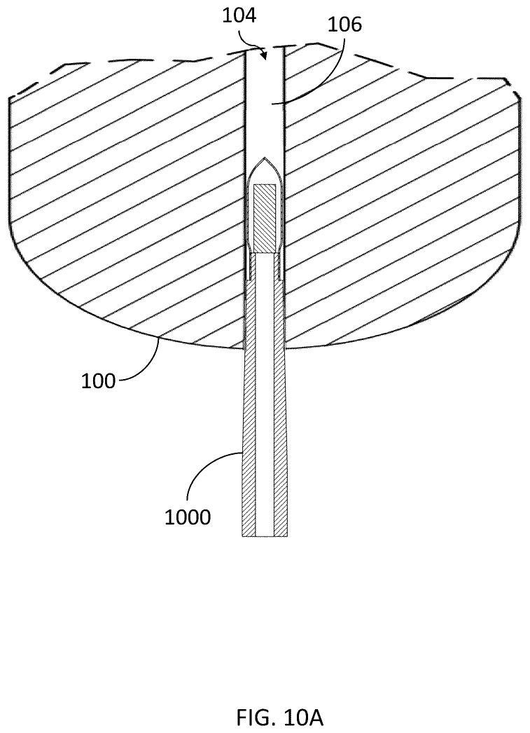

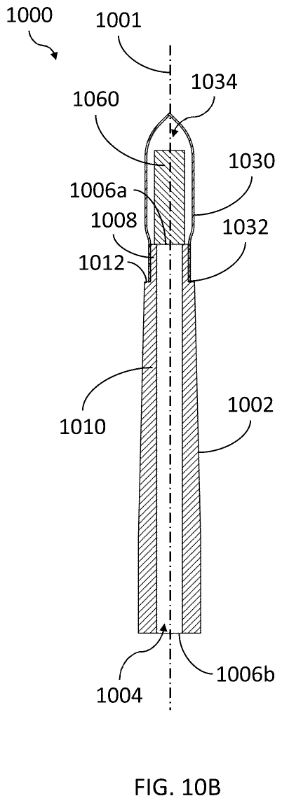

FIGS. 10A and 10B schematically illustrate another exemplary tip plug 1000 that may foam at evaluated temperature and/or reduced pressure for sealing the center hole 104 of the soot preform 100.

### Shaft

Referring to FIG. 10B, from which the soot preform 100 has been removed to better illustrate the details of the tip plug 1000, in some embodiments, the tip plug 1000 may include a shaft 1002 and a through hole 1004 extending through opposite first and second ends 1006a, 1006b of the shaft 1002 along the longitudinal axis 1001 of the tip plug 1000. In some embodiments, the shaft 1002 may be tapered such that the transverse dimension, e.g., diameter, of the shaft 1002 may gradually decrease from the second end 1006b towards the first end 1006a. The first end 1006a of the shaft 1002 may be inserted into the center hole 104 of the soot preform 100, and the tip plug 1000 may be held in place by friction fit of the shaft 1002 inside the center hole 104 of the soot preform 100. In some embodiments, the shaft 1002 may include a fully densified glass material. In some embodiments, the shaft 1002 may include quartz glass, or similar materials.

In some embodiments, the shaft 1002 of the tip plug 1000 may include a neck portion 1008 extending from the first end 1006a along a portion of the length of the shaft 1002 and a body portion 1010 extending from the neck portion 1008 through the remaining portion of the length of the shaft 1002 to the second end 1006b. In some embodiments, the neck portion 1008 may include a further reduced diameter as compared to the diameter of the body portion 1010, and a shoulder 1012 between the neck portion 1008 and the body portion 1010 may be formed. While the shaft 1002 illustrated in FIGS. 10A and 10B may include the neck portion 1008 and the shoulder 1012, in some embodiments, the shaft 1002 may not include the neck portion 1008 or the shoulder 1012, and the shaft 1002 may include a smooth taper between the first end 1006a and the second end 1006b.

### Cap

In some embodiments, the tip plug 1000 may further include a cap 1030 disposed at the first end 1006a of the shaft 1002, with the first end 1006a of the shaft 1002 received inside the cap 1030. In some embodiments, the cap 1030 may be supported in part by the shoulder 1012 of the shaft 1002. In some embodiments, the cap 1030 may be further coupled to the shaft 1002 by joining an inner surface portion near the open end 1032 of the cap 1030 to the outer surface of the neck portion 1008 via welding, adhesive, or any other suitable techniques. Thus, the cap 1030 may form a compartment 1034 atop the first end 1006a of the shaft 1002.

An expanding pellet 1060 (discussed in more detail below) formed of a material prone to foaming and expansion at elevated temperature and/or reduced pressure may be disposed inside the compartment 1034. When the expanding pellet 1060 foams and expands, the compartment 1034 may also expand, and the cap 1030 may be joined to the shaft 1002, e.g., to the neck portion 1008 of the shaft 1002, in a manner such that the cap 1030 may remain attached to the shaft 1002, causing the expanded cap 1030 to laminate to the interior surface 106 of the center hole 104 of the soot preform 100, thereby sealing the center hole 104 of the soot preform 100.

By enclosing the expanding pellet 1060 inside the cap 1030, contamination of the center hole 104 of the soot preform 100 by the foaming material forming the expanding pellet 1060 may be prevented. Further, with the cap 1030 being laminated to the interior surface 106 of the soot preform 100, a more reliable seal than the expanding pellet 1060 alone may be achieved. Without intending to be bound by theory, the expanding pellet 1060 may include a porous structure, and when used alone without the cap 1030, processing gas may enter the porous structure of the expanding pellet 1060 and may then be released into the center hole 104 of the soot preform 100.

In some embodiments, the cap 1030 may include a doped silica glass material such that the cap 1030 may have a relatively low viscosity at the processing temperature of the soot preform 100 to allow deformation and expansion of the cap 1030 for sealing the center hole 104 of the soot preform 100. In some embodiments, the dopant in the doped silica glass material for forming the cap 1030 may include fluorine, phosphorus, and the like. As a non-limiting example, in some embodiments, the cap 1030 may include a fluorine doped glass material having a fluorine concentration of greater than or equal to (i.e., ≥) 0.29 wt % and less than or equal to (i.e., ≤) 1.5 wt %—including all sub-ranges or values therebetween.

In some embodiments, the glass material of the cap 1030 may have a viscosity greater than or equal to (i.e., ≥) 10⁵ poise and less than or equal to (i.e., ≤) 10⁹ poise—including all sub-ranges or values therebetween, in the temperature range of 1100° C. to 1400° C. In some embodiments, the viscosity of the glass composition may be less than or equal to (i.e., ≤) 10⁹ poise at 1100° C. Further, in some embodiments, the viscosity of the glass composition may be greater than or equal to (i.e., ≥) 10⁵ poise at 1400° C.

In some embodiments, a thickness of the glass material forming the cap 1030 may be greater than or equal to (i.e., ≥) 0.5 mm and less than or equal to (i.e., ≤) 2 mm—including all sub-ranges or values therebetween. The thickness of the cap 1030 may be configured such that the cap 1030 may deform and expand along with the expanding pellet 1060 without breaking. For example, in some embodiments, the thickness of the glass material forming the cap 1030 may be ≥0.5 mm and ≤2 mm, ≥0.5 mm and ≤1.5 mm, ≥0.5 mm and ≤1 mm, ≥1 mm and ≤2 mm, ≥1 mm and ≤1.5 mm, or ≥1.5 mm and ≤2 mm. In some embodiments, the thickness of the glass material forming the cap 1030 may be greater than or equal to (i.e., ≥) 0.5 mm, ≥0.75 mm, ≥1 mm, ≥1.25 mm, ≥1.5 mm, ≥1.75 mm, or greater. In some embodiments, the thickness of the glass material forming the cap 1030 may be less than or equal to (i.e., ≤) 2 mm, ≤1.75 mm, ≤1.5 mm, ≤1.25 mm, ≤1 mm, ≤0.75 mm, or less.

### Expanding Pellet

As mentioned above, in some embodiments, the tip plug 1000 may further include an expanding pellet 1060 formed from a glass composition that may form at elevated temperature and/or reduced pressure.

In some embodiments, the glass composition forming the expanding pellet 1060 may include silica (SiO₂). In some embodiments, the amount of SiO₂ in the glass composition forming the expanding pellet 1060 may be ≥70 mol % and ≤95 mol %—including all sub-ranges or values therebetween. For example, in some embodiments, the amount of SiO₂ in the glass composition may be ≥70 mol % and ≤95 mol %, ≥70 mol % and ≤90 mol %, ≥70 mol % and ≤85 mol %, ≥70 mol % and ≤80 mol %, ≥70 mol % and ≤75 mol %, ≥75 mol % and ≤95 mol %, ≥75 mol % and ≤90 mol %, ≥75 mol % and ≤85 mol %, ≥75 mol % and ≤80 mol %, ≥80 mol % and ≤95 mol %, ≥80 mol % and ≤90 mol %, ≥80 mol % and ≤85 mol %, ≥85 mol % and ≤95 mol %, ≥85 mol % and ≤90 mol %, or ≥90 mol % and ≤95 mol %. In some embodiments, the amount of SiO₂ in the glass composition may be greater than or equal to (i.e., ≥) 70 mol %, ≥72.5 mol % ≥75 mol %, ≥77.5 mol %, ≥80 mol %, ≥82.5 mol %, ≥85 mol %, ≥87.5 mol %, ≥90 mol %, ≥92.5 mol %, or greater. In some embodiments, the amount of SiO₂ in the glass composition may be less than or equal to (i.e., ≤) 95 mol %, ≤92.5 mol %, ≤90 mol %, ≤87.5 mol %, ≤85 mol %, ≤82.5 mol %, ≤80 mol %, ≤77.5 mol %, ≤75 mol %, ≤72.5 mol %, or less.

In some embodiments, the glass composition forming the expanding pellet 1060 may further include phosphorus pentoxide (P₂O₅). In some embodiments, the amount of P₂O₅ in the glass composition forming the expanding pellet 1060 may be greater than or equal to (i.e., ≥) 5 mol % and less than or equal to (i.e., ≤) 30 mol %—including all sub-ranges or values therebetween. For example, in some embodiments, the amount of P₂O₅ in the glass composition forming the expanding pellet 1060 may be ≥5 mol % and ≤30 mol %, ≥5 mol % and ≤25 mol %, ≥5 mol % and ≤20 mol %, ≥5 mol % and ≤15 mol %, ≥5 mol % and ≤10 mol %, ≥10 mol % and ≤30 mol %, ≥10 mol % and ≤25 mol %, ≥10 mol % and ≤20 mol %, ≥10 mol % and ≤15 mol %, ≥15 mol % and ≤30 mol %, ≥15 mol % and ≤25 mol %, ≥15 mol % and ≤20 mol %, ≥20 mol % and ≤30 mol %, ≥20 mol % and ≤25 mol %, or ≥25 mol % and ≤30 mol %. In some embodiments, the amount of P₂O₅ in the glass composition forming the expanding pellet 1060 may be greater than or equal to (i.e., ≥) 5 mol %, ≥7 mol % ≥9 mol %, ≥11 mol % ≥13 mol %, ≥15 mol % ≥17 mol % ≥19 mol % ≥21 mol % ≥23 mol %, ≥25 mol % ≥27 mol %, ≥29 mol %, or greater. In some embodiments, the amount of P₂O₅ in the glass composition forming the expanding pellet 1060 may be less than or equal to (i.e., ≤) 30 mol %, ≤28 mol %, ≤26 mol %, ≤24 mol %, ≤22 mol %, ≤20 mol %, ≤18 mol %, ≤16 mol %, ≤14 mol %, ≤12 mol %, ≤10 mol %, ≤8 mol %, ≤6 mol %, or less.

Without intending to be bound by theory, the amount of P₂O₅ described herein may reduce the viscosity of the glass composition significantly to facilitate expansion of the expanding pellet 1060 without adversely affecting the attenuation of the optical fiber drawn from the soot preform 100, if any phosphorus may enter the center hole 104 or other portions of the soot preform 100 during processing. In contrast, although boron may also reduce the viscosity of the glass composition, boron may also increase the attenuation of the optical fiber drawn from the soot preform 100 if boron enters the center hole 104 or other portions of the soot preform 100. Thus, in some embodiments, the glass composition forming the expanding pellet 1060 may not include boron (B), or the amount of boron in the glass composition may be less than or equal to (i.e., ≤) 0.1 mol %, ≤0.05 mol %, ≤0.01 mol %, or less.

In some embodiments, the glass composition forming the expanding pellet 1060 may have a viscosity greater than or equal to (i.e., ≥) 10⁵ poise and less than or equal to (i.e., ≤) 10⁹ poise—including all sub-ranges or values therebetween, in the temperature range of 1100° C. to 1400° C. In some embodiments, the viscosity of the glass composition may be less than or equal to (i.e., ≤) 10⁹ poise at 1100° C. Further, in some embodiments, the viscosity of the glass composition may be greater than or equal to (i.e., ≥) 10⁵ poise at 1400° C.

In some embodiments, the glass composition forming the expanding pellet 1060 may further include a nucleating agent, similar to those described above with reference to tip plug 200, to further facilitate the expansion of the expanding pellet 1060. In some embodiments, the nucleating agent may include a relative stable or inert material, such as a metal oxide, e.g., zirconium oxide (ZrO₂), titanium oxide (TiO₂), and the like. In some embodiments, the amount of the nucleating agent in the glass composition forming the expanding pellet 1060 may be greater than or equal to (i.e., ≥) 0.1 mol % and less than or equal to (i.e., ≤) 10 mol %—including all sub-ranges or values therebetween. For example, in some embodiments, the amount of the nucleating agent in the glass composition forming the expanding pellet 1060 may be ≥0.1 mol % and ≤10 mol %, ≥0.1 mol % and ≤7.5 mol %, ≥0.1 mol % and ≤5 mol %, ≥0.1 mol % and ≤2.5 mol %, ≥2.5 mol % and ≤10 mol %, ≥2.5 mol % and ≤7.5 mol %, ≥2.5 mol % and ≤5 mol %, ≥5 mol % and ≤10 mol %, ≥5 mol % and ≤7.5 mol %, or ≥7.5 mol % and ≤10 mol %. In some embodiments, the amount of the nucleating agent in the glass composition forming the expanding pellet 1060 may be greater than or equal to (i.e., ≥) 0.1 mol %, ≥1 mol %, ≥1.5 mol %, ≥2 mol %, ≥2.5 mol %, ≥3 mol %, ≥3.5 mol %, ≥4 mol %, ≥4.5 mol %, ≥5 mol %, ≥5.5 mol %, ≥6 mol %, ≥6.5 mol %, ≥7 mol %, ≥7.5 mol %, ≥8 mol %, ≥8.5 mol %, ≥9 mol %, ≥9.5 mol %, or greater. In some embodiments, the amount of the nucleating agent in the glass composition forming the expanding pellet 1060 may be less than or equal to (i.e., ≤) 10 mol %, ≤9.5 mol %, ≤9 mol %, ≤8.5 mol %, ≤8 mol %, ≤7.5 mol %, ≤7 mol %, ≤6.5 mol %, ≤6 mol %, ≤5.5 mol %, ≤5 mol %, ≤4.5 mol %, ≤4 mol %, ≤3.5 mol %, ≤3 mol %, ≤2.5 mol %, ≤2 mol %, ≤1.5 mol %, ≤1 mol %, ≤0.5 mol %, or less.

### Expansion Upon Reheating

The inventors have unexpectedly discovered that the volume of phosphate glass composition described herein may expand significantly and/or rapidly at elevated temperature and/or reduced pressure. During processing of the soot preform 100, the tip plug 1000, more specifically, the cap 1030, the enclosed expanding pellet 1060, and a portion of the shaft 1002 may be placed inside the center hole 104 of the soot preform 100 and held in place by friction fit between the shaft 1002 and the interior surface 106 of the soot preform 100 as shown in FIG. 10A. The soot preform 100, as well as the tip plug 1000, may be exposed to an environment of elevated temperature and/or reduced pressure, prior to flowing any processing gas into the environment for processing the soot preform 100. In some embodiments, the tip plug 1000 may be exposed to a vacuum environment. The through hole 1004 in the shaft 1002 of the tip plug 1000 may allow the expanding pellet 1060 to be exposed to the reduced pressure or vacuum to facilitate the expansion of the expanding pellet 1060. Upon exposure to the elevated temperature and/or the reduced pressure, the tip plug 1000, more specifically, the expanding pellet 1060 may expand.

Without intending to be bound by theory, the expanding pellet 1060 may include trapped gas bubbles (the inclusion of which will be discussed in more detail below). When the tip plug 1000 may be exposed to the elevated temperature, the viscosity of the glass composition forming the expanding pellet 1060 may reduce, e.g., reduce to 10⁵ to 10⁹ poise or 107 to 108 poise, and thus, may deform under the pressure of the trapped gas bubbles, allowing the trapped gas bubbles to expand. The expansion of the trapped gas bubbles may be further facilitated by exposing the expanding pellet 1060 to the reduced pressure or vacuum. Further, without intending to be bound by theory, the expansion of the expanding pellet 1060 at the elevated temperature and/or reduced pressure may also be attributable in part to the volatilization of a small fraction of P₂O₅ from the glass composition forming the expanding pellet 1060, although, under reduced pressure or vacuum condition, the expansion of the gas bubbles may contribute to the volume increase of the expanding pellet 1060 more significantly.

When the tip plug 1000 is exposed to the elevated temperature, the viscosity of the cap 1030 may also reduce to allow expansion of the cap 1030. Specifically, the volume increase of the expanding pellet 1060 may also cause the cap 1030 to expand and to be laminated to the interior surface 106 of the center hole 104 of the soot preform 100, thereby creating a seal for preventing the ingress of the processing gas which may be flowed subsequently for processing the soot preform 100. Depending on the temperature to which the soot preform 100 and the tip plug 1000 may be exposed subsequently, in some embodiments, the portion of the shaft 1002 received inside the center hole 104 of the soot preform 100 may also be joined or fused to the interior surface 106 of the soot preform 100, creating a further seal between the shaft 1002 and the interior surface 106 of the soot preform 100.

The expansion of each gas bubble may depend on the temperature and/or the pressure at which the expanding pellet 1060 may be exposed to. The overall expansion of the expanding pellet 1060 may depend on the volumetric fraction of all the gas bubbles trapped inside the expanding pellet 1060. Thus, by controlling the volumetric fraction of the trapped gas in the expanding pellet 1060 and/or the temperature and/or pressure to which the expanding pellet 1060 may be exposed, the macroscopic expansion of the expanding pellet 1060 during processing of the soot preform 100 may be controlled.

### Bubble Volumetric Fraction

In some embodiments, the volumetric fraction of the gas bubbles inside the expanding pellet 1060 may be greater than or equal to (i.e., ≥) 1% and less than or equal to (i.e., ≤) 10%—including all sub-ranges or values therebetween. For example, in some embodiments, the volumetric fraction of the gas bubbles of the expanding pellet 1060 may be ≥1% and ≤10%, ≥1% and ≤7.5%, ≥1% and ≤5%, ≥1% and ≤2.5%, ≥2.5% and ≤10%, ≥2.5% and ≤7.5%, ≥2.5% and ≤5%, ≥5% and ≤10%, ≥5% and ≤7.5%, or ≥7.5% and ≤10%. In some embodiments, the volumetric fraction of the gas bubbles of the expanding pellet 1060 may be greater than or equal to (i.e., ≥) 1%, ≥2%, ≥3%, ≥4%, ≥5%, ≥6%, ≥7%, ≥8%, ≥9%, or greater. In some embodiments, the volumetric fraction of the gas bubbles of the expanding pellet 1060 may be less than or equal to (i.e., ≤) 10%, ≤9%, ≤8%, ≤7%, ≤6%, ≤5%, ≤4%, ≤3%, ≤2%, or less. The volumetric fraction of the trapped gas bubbles may be measured in accordance with ASTM C0693.

### Expanding Temperatures

In some embodiments, the temperature at which the expanding pellet 1060 may expand may be greater than or equal to (i.e., ≥) 1100° C. and less than or equal to (i.e., ≤) 1400° C.—including all sub-ranges or values therebetween. For example, in some embodiments, the temperature at which the expanding pellet 1060 may expand may be ≥1100° C. and ≤1400° C., ≥1100° C. and ≤1350° C., ≥1100° C. and ≤1300° C., ≥1100° C. and ≤1250° C., ≥1100° C. and ≤1200° C., ≥1100° C. and ≤1150° C., ≥1150° C. and ≤1400° C., ≥1150° C. and ≤1350° C., ≥1150° C. and ≤1300° C., ≥1150° C. and ≤1250° C., ≥1150° C. and ≤1200° C., ≥1200° C. and ≤1400° C., ≥1200° C. and ≤1350° C., ≥1200° C. and ≤1300° C., ≥1200° C. and ≤1250° C., ≥1250° C. and ≤1400° C., ≥1250° C. and ≤1350° C., ≥1250° C. and ≤1300° C., ≥1300° C. and ≤1400° C., ≥1300° C. and ≤1350° C., or ≥1350° C. and ≤1400° C. In some embodiments, the temperature at which the expanding pellet 1060 may expand may be greater than or equal to (i.e., ≥) 1100° C., ≥1125° C., ≥1150° C., ≥1175° C., ≥1200° C., ≥1225° C., ≥1250° C., ≥1275° C., ≥1300° C., ≥1325° C., ≥1350° C., ≥1375° C., or greater. In some embodiments, the temperature at which the tip plug 200 may expand may be less than or equal to (i.e., ≤) 1400° C., ≤1375° C., ≤1350° C., 1325° C., ≤1300° C., ≤1275° C., ≤1250° C., ≤1225° C., ≤1200° C., ≤1175° C., ≤1150° C., ≤1125° C., or less.

### Expanding Pressures

In some embodiments, the pressure at which the expanding pellet 1060 may expand may be greater than or equal to (i.e., ≥) 0 atm (or vacuum) and less than or equal to 1 atm—including all sub-ranges or values therebetween. For example, in some embodiments, the pressure at which the expanding pellet 1060 may expand may be ≥0 atm and ≤1 atm, ≥0 atm and ≤0.7 atm, ≥0 atm and ≤0.3 atm, ≥0.3 atm and ≤1 atm, ≥0.3 atm and ≤0.7 atm, or ≥0.7 atm and ≤1 atm. In some embodiments, the pressure at which the expanding pellet 1060 may expand may be greater than or equal to (i.e., ≥) 0 atm, ≥0.1 atm, ≥0.2 atm, ≥0.3 atm, ≥0.4 atm, ≥0.5 atm, ≥0.6 atm, ≥0.7 atm, ≥0.8 atm, ≥0.9 atm, or greater. In some embodiments, the pressure at which the expanding pellet 1060 may expand may be less than or equal to (i.e., ≤) 1 atm, ≤0.9 atm, ≤0.8 atm, ≤0.7 atm, ≤0.6 atm, ≤0.5 atm, ≤0.4 atm, ≤0.3 atm, ≤0.2 atm, ≤0.1 atm, or less.

### Expansion Ratio

In some embodiments, the expansion ratio of the expanding pellet 1060 described herein, as defined by the ratio of the expanded volume to the volume prior to expansion, may be greater than or equal to (i.e., ≥) 1.05 and less than or equal to (i.e., ≤) 5—including all sub-ranges or values therebetween. For example, in some embodiments, the expansion ratio of the expanding pellet 1060 may be ≥1.05 and ≤5, ≥1.05 and ≤4, ≥1.05 and ≤3, ≥1.05 and ≤2, ≥2 and ≤5, ≥2 and ≤4, ≥2 and ≤3, ≥3 and ≤5, ≥3 and ≤4, or ≥4 and ≤5. In some embodiments, the expansion ratio of the expanding pellet 1060 may be greater than or equal to (i.e., ≥) 1.05, ≥1.5, ≥2, ≥2.5, ≥3, ≥3.5, ≥4, ≥4.5, or greater. In some embodiments, the expansion ratio of the expanding pellet 1060 may be less than or equal to (i.e., ≤) 5, ≤4.5, ≤4, ≤3.5, ≤3, ≤2.5, ≤2, ≤1.5, or less. In addition to expanding significantly in volume, the expanding pellet 1060 described herein may also expand rapidly. In some embodiments, an expansion ratio of 1.1 may be obtained in less than or equal to (i.e., ≤) 10 minutes, ≤5 minutes, ≤1 minutes, ≤30 seconds, ≤20 seconds, ≤10 seconds, or less.

### Preparing Expanding Pellet

To prepare the expanding pellet 1060, silica soot may be first mixed with a phosphate precursor and optionally, a nucleating agent in some embodiments. In some embodiments, the phosphate precursor may be in the form of a loose powder. In some embodiments, the phosphate precursor may be in the form of a solution. In some embodiments, the phosphate precursor may include phosphoric acid (H₃PO₄) solution. In some embodiments, the phosphate precursor may include mono ammonium phosphate (NH₄H₂PO₄) in the form of either loose powder or solution. In some embodiments, the phosphate precursor may include P₂O₅ loose powder.

In some embodiments, loose powders of the silica soot, the phosphate precursor, and/or the nucleating agent may be mixed to form the batch material for preparing the expanding pellet 1060. In some embodiments, loose powders of the silica soot and/or the nucleating agent may be mixed with the phosphate precursor solution to form the batch material. In some embodiments, a porous, soot blank of silica may be solution doped with the phosphate precursor by submerging the silica soot blank in the solution of the phosphate precursor to form the batch material for preparing the expanding pellet 1060. In some embodiments, the mixing of the various powders and/or the solution doping of the silica soot blank with the phosphate precursor may be conducted at room temperature.

In the embodiments where a solution of the phosphate precursor is used for forming the batch material, the batch material may be heated to remove the solvent, which may include water. For example, in some embodiments, the batch material may be heated at a temperature at about 100° C. in an environment not saturated with water vapor. In some embodiments, forced circulation of air around the batch material may facilitate the removal of the water vapor evaporating from the batch material. In the embodiments where a phosphate precursor powder may be used, the drying step may be omitted.

After drying to remove water, in some embodiments, the batch material may be further heated to dehydrate the phosphate precursor. For example, in some embodiments, the batch material may be heated at a temperature range between 360° C. and 420° C. to dehydrate H₃PO₄ or NH₄H₂PO₄ into P₂O₅ by removing H₂O and/or NH₃ from the phosphate precursor. During dehydration, a small fraction of P₂O₅ may be lost due to volatilization; however, the dehydration temperature may not be too high such that the majority may remain inside the porous structure of the batch material. By removing the solvent, e.g., water, from the batch material at a lower temperature followed by dehydrating the batch material at a higher temperature, controlled drying and/or dehydration may be achieved, and the structure of the mixed batch material may be preserved. In the embodiments where P₂O₅ loose powder may be used as the phosphate precursor, the dehydration step may be omitted.

After dehydration, in some embodiments, the batch material may be melted in order to achieve mixing at the molecular level so that the P₂O₅ may function as a network modifier to reduce the viscosity of the resultant glass composition. In some embodiments, the batch material may be melted at a temperature of about 1500° C. to 1600° C. In some embodiments, the melting time, i.e., the time duration for which the batch material may be maintained in the molten state, may be greater than or equal to (i.e., ≥) 1 hours and less than or equal to (i.e., ≤) 5 hours at around 1500° C. to 1600° C. The melting time may be selected to allow P₂O₅ to be incorporated into the glass network while limiting the amount of gas that may be removed from the melted batch material.

After melting, the molten batch material may then be cooled to form a glass body. In some embodiments, the glass body may be further machined, e.g., cut, to form the expanding pellet 1060. In some embodiments, the molten batch material may be poured into a mold to form the expanding pellet 1060.

In some embodiments, instead of melting the batch material, the dehydrated batch material may be sintered. For example, in some embodiments, the dehydrated batch material may be pressed to form a porous body. Controlled densification of the dehydrated batch material may be achieved by rapidly overheating the outer surface of the porous body to generate a fully densified layer for containing the residual gas trapped inside the open pores to form the expanding pellet 1060.

While the expanding pellet 1060 containing P₂O₅ is described as a non-limiting example, the expanding pellet 1060 may be formed from other expanding materials. For example, any of the glass compositions and techniques described herein for forming the tip plug 200 may be used for forming the expanding pellet 1060 of the tip plug 1000.

Accordingly, the base matrix, the viscosity modifier, the foaming agent, and/or the nucleating agent described above for forming the tip plug 200 may be used for forming the expanding pellet 1060.

### Exemplary Expanding Pellet

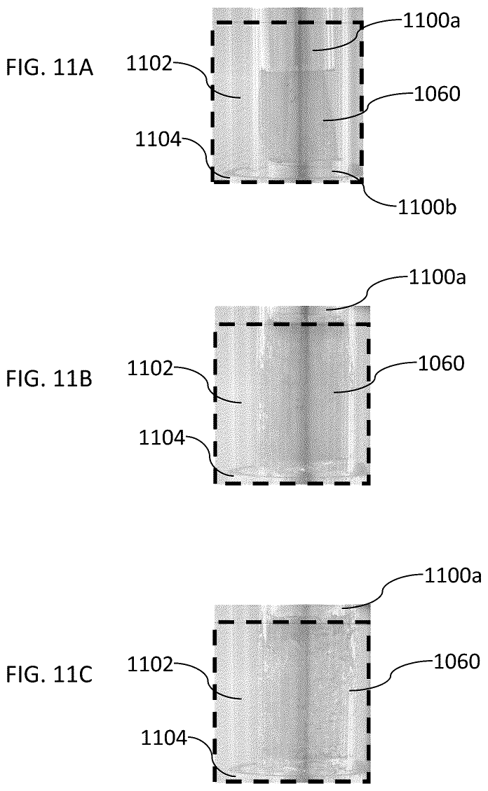

FIGS. 11A, 11B, and 11C illustrate the expansion behavior of an exemplary expanding pellet 1060 that is reheated and subjected to reduced pressure. The expanding pellet 1060 contains 15 mol % of P₂O₅. In the setup shown in FIGS. 11A, 11B, and 11C, the expanding pellet 1060 is positioned between two sections of silica glass 1100a, 1100b inside a silica glass tube 1102, all of which are held in a vertical position by a support tube 1104. The sections of the silica glass 1100a, 1100b, the silica glass tube 1102, and the support tube 1104 do not expand or deform under the conditions the expanding pellet 1060 is subjected to.

It should be noted that the setup shown in FIGS. 11A, 11B, and 11C is not the same configuration as the tip plug 1000, but constructed to demonstrate the expansion behavior of the expanding pellet 1060. The rectangular areas marked by the dashed lines in FIGS. 11A, 11B, and 11C are the same to serve as a reference for showing the relative position of the expanding pellet 1060.

In FIG. 11A, the expanding pellet 1060 is exposed to an elevated temperature of about 1140° C. and atmospheric pressure, i.e., 1 atm. In FIG. 11B, the temperature is further elevated to about 1300° C. while the pressure is reduced to 0.4 atm. As shown in FIG. 11B, the expanding pellet 1060 expands both radially (within a few seconds) and axially. In FIG. 11C, the same temperature of about 1300° C. is maintained while the pressure is increased back to 1 atm. As shown in FIG. 11C, the macroscopic expansion of the expanding pellet 1060 is substantially maintained when the pressure is returned to atmospheric pressure, with some voids formed by gas bubbles coalescing in the expanded expanding pellet 1060. Without intending to be bound by theory, the viscosity of the glass composition forming the expanding pellet 1060 described herein may be sufficiently low to allow the gas bubbles to expand under reduced pressure but at the same time not too low so that when the pressure is increased, which may be needed for further processing the soot preform 100, the expanded expanding pellet 1060 may not collapse, and may continue to imparting pressure onto the cap 1030 of the tip plug 1000, thereby ensuring the seal to prevent processing gas ingress into the center hole 104 of the soot preform 100.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A method of processing a soot preform having a center hole, the method comprising:
providing a tip plug, wherein at least one portion of the tip plug is received inside the center hole of the soot preform;
exposing the tip plug to an elevated temperature that is greater than or equal to 1100° C.; and
exposing the tip plug to a pressure that is less than or equal to 1 atm;
wherein exposing the tip plug to the elevated temperature and/or exposing the tip plug to the pressure causes the at least one portion of the tip plug to expand, thereby sealing the center hole of the soot preform;
wherein an expansion ratio of the at least one portion of the tip plug is greater than or equal to 1.05 within a period of less than or equal to 30 minutes, wherein the expansion ratio is defined as a ratio of a volume of the at least one portion of the tip plug at the end of the period to a volume of the at least one portion of the tip plug prior to expansion; and
wherein the soot preform remains porous until the center hole of the soot preform is sealed by the tip plug.

2. The method of claim 1, wherein the pressure to which the tip plug is exposed is greater than or equal to 0 atm and less than or equal to 0.3 atm.

3. The method of claim 1, wherein the temperature to which the tip plug is exposed is less than or equal to 1700° C.

4. The method of claim 1, wherein a viscosity of the at least one portion of the tip plug is less than or equal to 10⁹ poise at 1100° C. and/or greater than or equal to 10⁵ poise at 1400° C.

5. The method of claim 1, wherein the tip plug comprises a foaming agent, wherein the foaming agent is configured to cause the at least one portion of the tip plug to expand, thereby sealing the center hole of the soot preform without causing a gas to be released from the tip plug into the center hole of the soot preform.

6. The method of claim 1, wherein the tip plug comprises:
a shaft including a first end, a second end, and a through hole extending through the first end and the second;
a cap coupled to the first end of the shaft and defining a compartment; and
an expanding pellet disposed inside the compartment;
wherein the through hole of the shaft is configured for establishing fluid communication between the compartment defined by the cap and an environment in which the soot preform is processed;
wherein the at least one portion of the tip plug comprises the cap and the expanding pellet; and
wherein the expanding pellet is configured to expand, thereby causing the cap to expand and laminate to an interior surface of the soot preform defining the center hole of the soot preform to seal the center hole of the soot preform.

7. A tip plug configured for sealing a center hole of a soot preform during at least one processing step for processing the soot preform, wherein the soot preform remains porous during the at least one processing step, the tip plug comprising:
a glass composition comprising:
SiO₂ in an amount that is greater than or equal to 90 mol % and less than or equal to 99.9 mol %; and
a foaming agent;
wherein the foaming agent is configured to cause the tip plug to expand during the at least one processing step, thereby sealing the center hole of the soot preform without causing a gas to be released from the tip plug into the center hole of the soot preform; and
wherein the viscosity of the glass composition is less than or equal to 10⁹ poise at 1100° C. and/or greater than or equal to 10⁵ poise at 1400° C.

8. The tip plug of claim 7, wherein the at least one processing step comprises exposing the soot preform and the tip plug to an elevated temperature and/or a pressure that is greater than or equal to 0 atm and less than or equal to 1 atm, optionally wherein the elevated temperature is greater than or equal to 1100° C. and less than or equal to 1400° C., and wherein the foaming agent is volatile at the elevated temperature.

9. The tip plug of claim 7, wherein the foaming agent comprises a halide, optionally wherein the halide comprises a silicon halide, optionally wherein the silicon halide comprises at least one of SiF₄, SiCl₄, or SiBr₄.

10. The tip plug of claim 7, wherein the foaming agent reacts with SiO₂ or decomposes to release the gas product at the at least one processing step.

11. The tip plug of claim 7, wherein the glass composition further comprises a viscosity modifier, wherein an amount of the viscosity modifier is greater than or equal to 1.5 mol % and less than or equal to 5.5 mol %, optionally wherein the viscosity modifier comprises at least one of phosphorus (P), fluorine (F), chlorine (CI), boron (B), an alkali-containing material, or an alkaline-earth-containing material.

12. The tip plug of claim 7, wherein the glass composition further comprises a nucleating agent, wherein the nucleating agent comprises inert particles, and wherein an amount of the nucleating agent is greater than or equal to (i.e., ≥) 1 vol % and less than or equal to (i.e., ≤) 20 vol %, optionally wherein the nucleating agent comprises inert particles, optionally wherein the nucleating agent comprises a metal oxide, optionally wherein the metal oxide comprises at least one of zirconium oxide (ZrO₂) or titanium oxide (TiO₂).

13. The tip plug of claim 7, wherein the foaming agent is configured to cause the tip plug to achieve an expansion ratio of greater than or equal to 1.05 within a period of less than or equal to 30 minutes, wherein the expansion ratio is defined as a ratio of a volume of the tip plug at the end of the period to a volume of the tip plug prior to expansion.

14. A tip plug configured for sealing a center hole of a soot preform during at least one processing step for processing the soot preform, the tip plug comprising:
a shaft including a first end, a second end, and a through hole extending through the first end and the second;
a cap coupled to the first end of the shaft and defining a compartment, wherein the through hole of the shaft is configured for establishing fluid communication between the compartment defined by the cap and an environment in which the soot preform is processed during the at least one processing step; and
an expanding pellet disposed inside the compartment.

15. The tip plug of claim 14, wherein the expanding pellet is configured to expand during the at least one processing step, thereby causing the cap to expand and laminate to an interior surface of the soot preform defining the center hole of the soot preform to seal the center hole of the soot preform.

16. The tip plug of claim 14, wherein the expanding pellet comprises a glass composition comprising:
SiO₂ in an amount that is greater than or equal to 70 mol % and less than or equal to 95 mol %; and
P₂O₅ in an amount that is greater than or equal to 5 mol % and less than or equal to 30 mol %.

17. The tip plug of claim 16, wherein the expanding pellet comprises gas bubbles, and optionally wherein a volumetric fraction of the gas bubbles in the expanding pellet is greater than or equal to 1% and less than or equal to 10%.

18. The tip plug of claim 16, wherein the glass composition of the expanding pellet further comprises a nucleating agent in an amount that is greater than or equal to 0.1 mol % and less than or equal to 10 mol %.

19. The tip plug of claim 14, wherein the expanding pellet comprises a glass composition comprising:
SiO₂ in an amount that is greater than or equal to 90 mol % and less than or equal to 99.9 mol %; and
a foaming agent, wherein the foaming agent is volatile during the at least one processing step, or wherein the foaming agent is reactive and releases a gas product during the at least one processing step.

20. The tip plug of claim 14, wherein a thickness of the cap is greater than or equal to 0.5 mm and less than or equal to 2 mm.
